(19) United States
(12) Patent Application Publication
(10) Pub. No.: US 2006/0253885 A1
(43) Pub. Date: Nov. 9, 2006

(54) Wireless surveillance system

(76) Inventors: Greg Murphy, Kailua, HI (US); Knight Hamalian, Honolulu, HI (US)

Correspondence Address: JOHN R. ROSS;TREX ENTERPRISES CORP., 10455 PACIFIC CENTER CT., SAN DIEGO, CA, 92121, US

(21) Appl. No.: 11/392,400

(22) Filed: Mar. 28, 2006

Related U.S. Application Data
(60) Provisional application No. 60/666,084, filed on Mar. 28, 2005.
(60) Provisional application No. 60/691,270, filed on Jun. 15, 2005.

(51) Int. Cl. H04N 7/173

(52) U.S. Cl. 725/105

(57) ABSTRACT

A surveillance system utilizing a mesh network having a large number of surveillance cameras. A plurality of limited range transceivers in direct or indirect communication with one or more of the cameras are located at a large number of nodes and are in communication with other transceivers in the network and are in communication with a control station. In a preferred embodiment most of the nodes are equipped with three transceivers to provide simultaneous communication with one or more camera and at the same time receive and transmit information from other nodes. This system utilizes a routing protocol that was initially developed for wireless voice-over Internet protocol services to large regions. This preferred system incorporates transceiver chips that enable communications over multiple frequencies and communications protocols. The signals from multiple frequencies are then converted into a digital format for routing to central command and control facilities, which can in turn communicate with mobile nodes. The use of multiple frequencies will enable simultaneous communication from multiple inputs without the bandwidth constraints of Wi-Fi systems that are designed for point-to-point Internet access. In addition, the use of a mesh network also enables redundancy to allow reliable communications even when one node or channel fails and enhanced security due to random channel allocation. The surveillance units may be mounted on light poles including street light poles. The also could be incorporated into light fixtures that are in turn mounted on the light poles.

This application claims the benefit of Provisional Patent Applications, Ser. No. 60/666,084 filed Mar. 28, 2005 and Ser. No. 60/691,270 filed Jun. 15, 2005. The present invention relates to surveillance and security systems and in particular to wireless surveillance security systems.

### BACKGROUND OF THE INVENTION

### Need for Security

Especially since Sep. 9, 2001 security has become big business in the United States and in most countries of the world. People and governments are concerned with the protection of locations that are terrorist targets. These include stadiums, government installations and military installations. Most terrorist targets are equipped with perimeter outdoor lighting.

### Local Wireless Radio Communication

Local wireless communication services represent a very rapidly growing industry. Wireless communication equipment in the Unites States includes equipment known as “Wireless Fidelity” equipment (also called “WiFi” or “Wireless Networking”). This equipment operates in unlicensed spectral ranges. In order to limit interference among signals, however, transmitted power of WiFi systems is limited. For some services such as cellular telephone services spectral ranges are strictly licensed by region by the federal government.

### Closed Circuit Television

The worldwide CCTV market is growing at a fast pace to a projected $8 billion by 2008. We believe that a video surveillance network with a mesh architecutre will address a meaningful niche opportunity for wide- and dense-area surveillance systems. Examples of applications include urban video monitoring systems for law enforcement, wide-area perimeter security systems and single-building systems that require protection for multiple sites at the building.

### Wireless Fidelity Equipment

Wireless fidelity equipment is widely available in the Unites States. It is widely used to connect notebook type computers to the Internet. This type of equipment is designed to standard protocols known as the 802.11b and 802.11g protocols so that transmitted signals to and from the equipment is compatible with Ethernet network systems. That is, the wireless link between WiFi equipment replaces cables in a wired Ethernet system. This equipment operates within the spectral range of 2.412 GHz to 2.462 GHz. This equipment is equipped with either an omni-directional antenna that provides communication in all directions but at maximum distances of only a few hundred feet or a directional antenna that can provide communication at distances or up to a mile or more. Mesh networks are available in which one or more wireless transceivers are located at a large number of sites, called nodes, each node in communication with at least one other node. With such a mesh network communication is provided throughout the mesh network by having the information “hop” between nodes until it gets from the sender to the intended receiver. Mesh Dynamics Corporation with offices in Santa Clara, Calif. provides a mesh network, using a structured mesh routing protocol, in which each node is equipped with three transceivers for a voice over Internet protocol communications system.

### Remote WiFi Camera Systems

Remote wireless cameras with built-in wireless fidelity communication equipment is currently available from many suppliers such as for example the Wireless Observer XT unit available online at the Internet from Veo International. Equipment available from Veo includes a motion detector that will turn on the remote camera when motion is detected in its field of view transmit the camera's signal (including sound) to a personnel computer. Frame rates up to 30frames per second are provided. The motion detector can initiate an e-mail that transmits a signal to turn off the camera when the motion ceases. WiFi signals from these remote wireless cameras can be transmitted to a personal computer connected to the Internet and the personal computer can be accessed from just about anywhere in the world. So a person in Singapore can see what is happening in his back yard in San Diego, Calif., just by logging on to his computer that is connected to the Internet. The Observer XT camera has a pan and tilt direction control so the person in Singapore can view his entire San Diego back yard.

### Cellular Telephones

The cellular telephone industry currently is in its second generation with several types of cellular telephone systems being promoted. The cellular market in the United States grew from about 2 million subscribers and $2 million in revenue in 1988 to more than 60 million subscribers about $30 billion in revenue in 1998 and the growth is continuing in the United States and also around the world as the services become more available and prices decrease.

FIG. 5 describes a typical cellular telephone system. A cellular service provider divides its territory up into hexagonal cells as shown in FIG. 5. These cells may be about 5 miles across, although in densely populated regions with many users these cells may be broken up into much smaller cells called micro cells. This is done because cellular providers are allocated only a limited portion of the radio spectrum. For example, one spectral range allocated for cellular communication is the spectral range: 824 MHz to 901 MHz. (Another spectral range allocated to cellular service is 1.8 GHz to 1.9 GHz) A provider operating in the 824 -901 MHz range may set up its system for the cellular stations to transmit in the 824 MHz to 851 MHz range and to receive in the 869 MHz to 901 MHz range. The transmitters both at the cellular stations and in devices used by subscribers operate at very low power Oust a few Watts) so signals generated in a cell do not provide interference in any other cells beyond immediate adjacent cells. By breaking its allocated transmitting spectrum and receive spectrum in seven parts (A-G) with the hexagonal cell pattern, a service provider can set up its system so that there is a two-cell separation between the same frequencies for transmit or receive, as shown in FIG. 5. A one-cell separation can be provided by breaking the spectrum into three parts. Therefore, these three or seven spectral ranges can be used over and over again throughout the territory of the cellular service provider. In a typical cellular system each cell (with a transmit bandwidth and a receive bandwidth each at about 12 MHz wide) can handle as many as about 1200 two-way telephone communications within the cell simultaneously. With lower quality communication, up to about 9000 calls can be handled in the 12 MHz bandwidth. Several different techniques are widely used in the industry to divide up the spectrum within a given cell. These techniques include analog and digital transmission and several techniques for multiplexing the digital signals. These techniques are discussed at pages 313 to 316 in The Essential Guide to Telecommunications, Second Edition, published by Prentice Hall and many other sources. Third generation cellular communication systems promise substantial improvements with more efficient use of the communication spectra.

### Other Prior Art Wireless Communication Techniques

### Point-to-Point and Point-to-Multi-Point

Most wireless communication, at least in terms of data transmitted is one way, point to multi-point, which includes commercial radio and television. There are many examples of point-to-point wireless communication. Cellular telephone systems, discussed above, are examples of low-data-rate, point-to-point communication. Microwave transmitters on telephone system trunk lines are another example of prior art, point-to-point wireless communication at much higher data rates. The prior art includes a few examples of point-to-point laser communication at infrared and visible wavelengths.

### Information Transmission

Analog techniques for transmission of information are still widely used; however, there has recently been extensive conversion to digital, and in the foreseeable future transmission of information will be mostly digital with volume measured in bits per second. To transmit a typical telephone conversation digitally utilizes about 5,000 bits per second (5 Kbits per second). Typical personal computer modems connected to the Internet operate at, for example, 56 Kbits per second. Music can be transmitted point to point in real time with good quality using MP3 technology at digital data rates of 64 Kbits per second. Video can be transmitted in real time at data rates of about 5 million bits per second (5 Mbits per second). Broadcast quality video is typically at 45 or 90 Mbps. Companies (such as line telephone, cellular telephone and cable companies) providing point-to-point communication services build trunk lines to serve as parts of communication links for their point-to-point customers. These trunk lines typically carry hundreds or thousands of messages simultaneously using multiplexing techniques. Thus, high volume trunk lines must be able to transmit in the gigabit (billion bits, Gbits, per second) range. Most modern trunk lines utilize fiber optic lines. A typical fiber optic line can carry about 2 to 10 Gbits per second and many separate fibers can be included in a trunk line so that fiber optic trunk lines can be designed and constructed to carry any volume of information desired virtually without limit. However, the construction of fiber optic trunk lines is expensive (sometimes very expensive) and the design and the construction of these lines can often take many months especially if the route is over private property or produces environmental controversy. Often the expected revenue from the potential users of a particular trunk line under consideration does not justify the cost of the fiber optic trunk line. Digital microwave communication has been available since the mid-1970's. Service in the 18-23 GHz radio spectrum is called “short-haul microwave” providing point-to-point service operating between 2 and 7 miles and supporting between four to eight T1 links (each at 1.544 Mbps). Recently, microwave systems operating in the 11 to 38 Ghz band have been designed to transmit at rates up to 155 Mbps (which is a standard transmit frequency known as “OC-3 Standard”) using high order modulation schemes.

### Data Rate and Frequency

Bandwidth-efficient modulation schemes allow, as a general rule, transmission of data at rates of about 1 to 8 bits per second per Hz of available bandwidth in spectral ranges including radio wave lengths to microwave wavelengths. Data transmission requirements of 1 to tens of Gbps thus would require hundreds of MHz of available bandwidth for transmission. Equitable sharing of the frequency spectrum between radio, television, telephone, emergency services, military and other services typically limits specific frequency band allocations to about 10% fractional bandwidth (i.e., range of frequencies equal to about 10% of center frequency). AM radio, at almost 100% fractional bandwidth (550 to 1650 GHz) is an anomaly; FM radio, at 20% fractional bandwidth, is also atypical compared to more recent frequency allocations, which rarely exceed 10% fractional bandwidth.

### Reliability Requirements

Reliability typically required for wireless data transmission is very high, consistent with that required for hard-wired links including fiber optics. Typical specifications for error rates are less than one bit in ten billion (10-10 bit-error rates), and link availability of 99.999% (5 minutes of down time per year). This necessitates all-weather link operability, in fog and snow, and at rain rates up to 100 mm/hour in many areas. On the other hand cellular telephone systems do not require such high reliability.

### Weather Conditions

In conjunction with the above availability requirements, weather-related attenuation limits the useful range of wireless data transmission at all wavelengths shorter than the very long radio waves. Typical ranges in a heavy rainstorm for optical links (i.e., laser communication links) are 100 meters, and for microwave links, 10,000 meters.

Atmospheric attenuation of electromagnetic radiation increases generally with frequency in the microwave and millimeter-wave bands. However, excitation of rotational modes in oxygen and water vapor molecules absorbs radiation preferentially in bands near 60 and 118 GHz (oxygen) and near 23 and 183 GHz (water vapor). Rain, which attenuates through large-angle scattering, increases monotonically with frequency from 3 to nearly 200 GHz. At the higher, millimeter-wave frequencies, (i.e., 30 GHz to 300 GHz corresponding to wavelengths of 1.0 centimeter to 1.0 millimeter) where available bandwidth is highest, rain attenuation in very bad weather limits reliable wireless link performance to distances of 1 mile or less. At microwave frequencies near and below 10 GHz, link distances to 10 miles can be achieved even in heavy rain with high reliability, but the available bandwidth is much lower.

### Small Cameras

Small digital cameras are available that are capable of operation at video rates or frame by frame. These cameras are equipped with pixel arrays and the pixels are typically charge couple devices (CCD's) or complementary metal oxide semiconductor (CMOS) devices. These cameras are currently being used extensively in cell phone to transmit images still or video via cell phone systems.

### Outdoor Lighting

Outdoor lighting is provided for most city streets throughout the United States. Parking lots at commercial and industrial facilities are also typically equipped with outdoor lights. Outdoor perimeter lights are also typically provided at industrial and commercial facilities. These are just particular examples; outdoor lighting in general is very common wherever there are people.

### Prior Art Security Systems Utilizing Outdoor Lights

The combining of outdoor lighting into a security system is well known. For example, U.S. Pat. No. 6,819,239 describes a lighting security system in which digital cameras and motion sensors are combined with outdoor lights. In that invention when a motion detector sensed motion one of the lights is caused to turn on and the turned on light caused all the other lights in the system to turn on and cameras associated with each light then records a portion of a region being monitored. This patent cites 21 related patents covering various security ideas.

### Wireless Surveillance

There is no viable solution today for large-scale deployment of video surveillance cameras throughout a large campus or metropolitan areas or at a single facility with large numbers of entrances and exits or other areas that require surveillance. There are various proprietary solutions that provide wireless for video surveillance as indicated above, but they use technology that was developed for wireless internet access, not high bandwidth video surveillance over either a wide area or that requires substantial density or cameras on a particular site.

### The Need

Homeland security is a top priority in the United States. Many thousands of facilities are potential targets of people that want to cause us harm. What we need is a surveillance system that covers a wide are is inexpensive and extremely easy to set up.

### SUMMARY OF THE INVENTION

The present invention provides a surveillance system utilizing a mesh network having a large number of surveillance cameras. A plurality of limited range transceivers in direct or indirect communication with one or more of the cameras are located at a large number of nodes and are in communication with other transceivers in the network and are in communication with a control station. In a preferred embodiment most of the nodes are equipped with three transceivers to provide simultaneous communication with one or more camera and at the same time receive and transmit information from other nodes. This system utilizes a routing protocol that was initially developed for wireless voice-over Internet protocol services to large regions. This preferred system incorporates transceiver chips that enable communications over multiple frequencies and communications protocols. The signals from multiple frequencies are then converted into a digital format for routing to central command and control facilities, which can in turn communicate with mobile nodes. The use of multiple frequencies will enable simultaneous communication from multiple inputs without the bandwidth constraints of Wi-Fi systems that are designed for point-to-point Internet access. In addition, the use of a mesh network also enables redundancy to allow reliable communications even when one node or channel fails and enhanced security due to random channel allocation. The surveillance units may be mounted on light poles including street light poles. The also could be incorporated into light fixtures that are in turn mounted on the light poles.

### BRIEF DESCRIPTION OF THE DRAWINGS

FIG. 1 shows a prior art cellular telephone system.

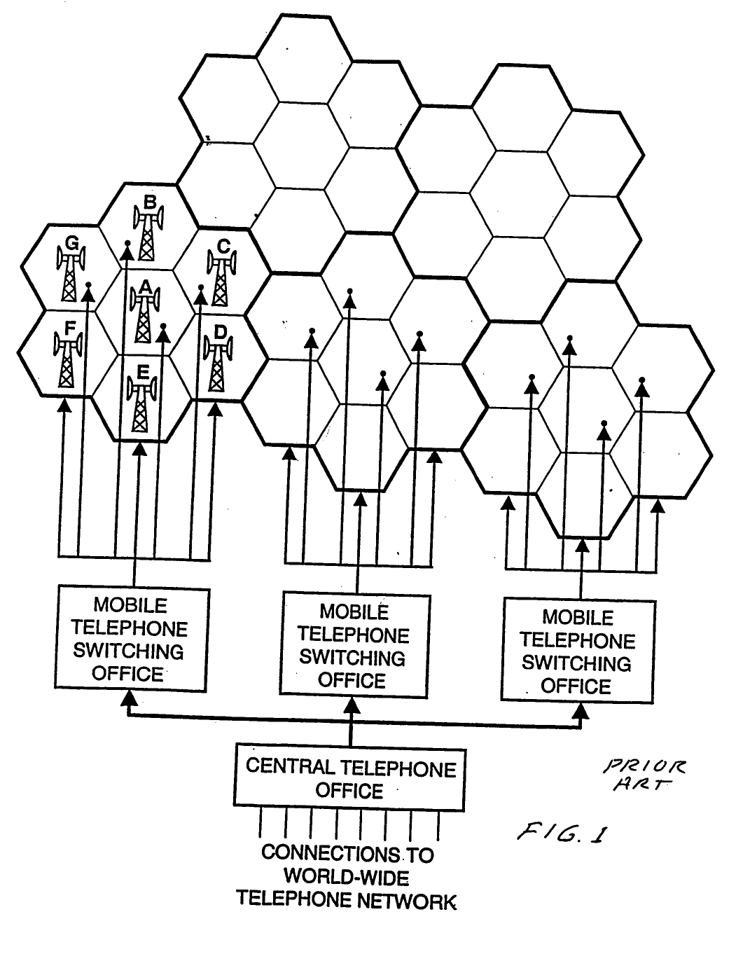

FIG. 2 drawing of a pole mounted surveillance unit, complete except for the off-the-shelf camera.

FIG. 3 shows a communication network.

### DETAILED DESCRIPTION OF PREFERRED EMBODIMENTS

### Wireless Mesh Network Surveillance System

A first preferred embodiment of the present invention provides a wireless video surveillance system that will allow Government agencies and security integrators to provide scalable city-wide infrastructures with an open platform for integration with their existing security and closed circuit television systems. One key element of the new system is based on a new mesh technology that provides multiple transceivers operating at various frequencies to allow for a highly scalable video infrastructure. Applicants have designed the system to maximize bandwidth, using multiple transceivers to enable deployment of wide-area and high-density surveillance systems. In addition, the system will enable automated threat detection as well as the security and redundancy advantages afforded by multiple-frequency systems incorporated into a mesh network architecture.

This preferred embodiment utilizes multiple transceivers (preferably three) at each node of the system providing substantial advantages in quality of communication among nodes as compared to single transceiver mesh networks. A single transceiver mesh network, also known as ad-hoc mesh architecture, must share the transmission and backhaul functions of the network on one communications channel. Conventional systems are designed for transmission of the video node layer with the Internet infrastructure with a line-of-sight communication method. Single transceiver systems enable creation of an ad hoc mesh to avoid the need for line-of-sight communications. These systems, however, must share bandwidth between their node transmission and backhaul to central office functions. Depending on the density of the network, the bandwidth of each node can be severely limited. As the density of the network increases, the need for backhaul bandwidth at each node can overwhelm the node transmission bandwidth of the network. A dual-transceiver network can minimize the impact of the backhaul burden on the network by devoting one of the transceivers to the backhaul function. Depending on the density of the network, however, the dual transceiver solution can also suffer from bandwidth constraints. Since the single channel providing network communication increase in usage will eventually slow down the system.

The three transceivers at each node provide simultaneous communication with one or more camera and at the same time receive and transmit information from other nodes. The routing protocol utilized by this preferred embodiment was initially developed for wireless voice-over Internet protocol services to large regions. This preferred system incorporates transceiver chips that enable communications over multiple frequencies and communications protocols. The signals from multiple frequencies are then converted into a digital format for routing to central command and control facilities, which can in turn communicate with mobile nodes. The use of multiple frequencies will enable simultaneous communication from multiple inputs without the bandwidth constraints of Wi-Fi systems that are designed for point-to-point Internet access. In addition, the use of a mesh network also enables redundancy to allow reliable communications even when one node or channel fails and enhanced security due to random channel allocation. Two of the transceivers can be dedicated to receiving and transmitting information to and from other nodes. Applicant's first preferred embodiment, however, is an intelligent version of the three-transceiver system. In this version there are no dedicated channels. Rather, the system intelligently allocates packets for node transmission and bandwidth functionality based on traffic requirements at the node and network as a whole.

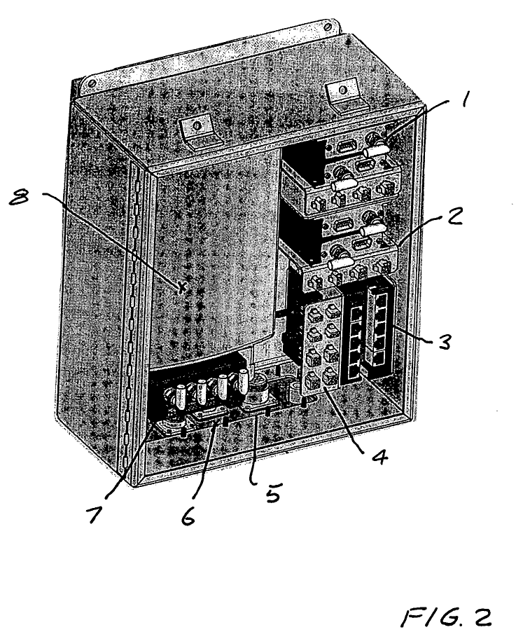

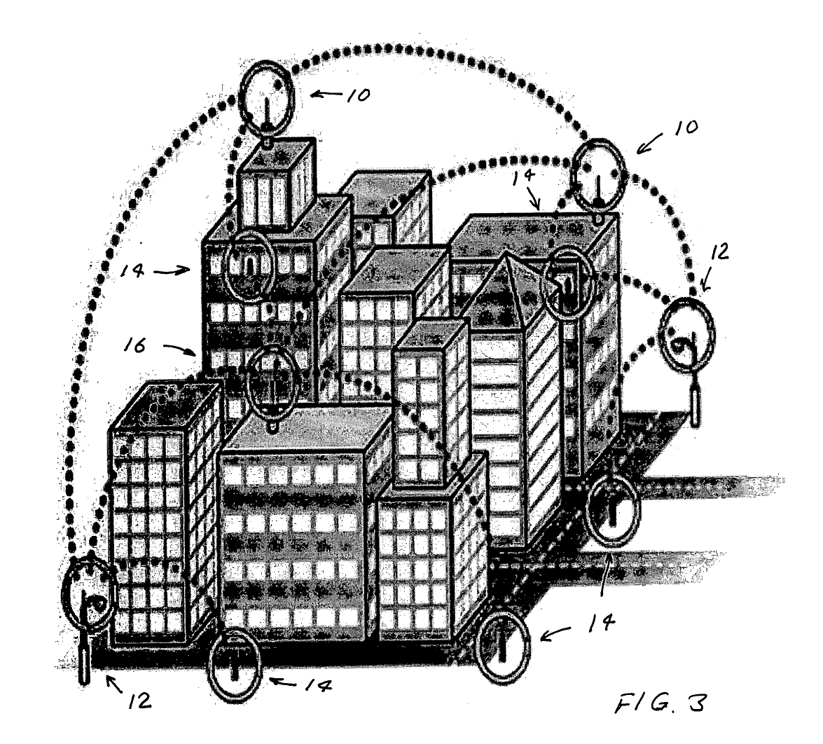

Preferred embodiments include pole mounted surveillance units and tripode mounted units. In both of these embodiments Applicants utilize have utilized off-the-shelf components to provide surveillance systems. Preferred embodiments provide designs that greatly simplifies the assembly operation. These designs reduce the assembly from about 16 man-hours to less than 1 man-hour per unit. A drawing of a pole mounted surveillance unit, complete except for the off-the- shelf camera is shown in FIG. 2. A 3 or 4 encoder set is shown at 1 and a 1 or 2 encoder set is shown at 2. A moxa LAN switch box is shown at 3. An interconnect panel is shown at 4. Applicants utilize a universal box as shown at 5. The camera connection with the unit location is shown at 6. The connector panel for power, internal camera connections LAN and radio are shown at 7. The location of the ballum and the pace rapid are shown at 8 and 9 respectively. The surveillance units may be mounted on light poles including street light poles. The also could be incorporated into light fixtures that are in turn mounted on the light poles. FIG. 3 shows a small communication network utilizing features of the present invention. Wireless mesh transmitter/receiver units are shown at 10. Two light pole mesh interfaces are shown at 12. Mobile person with a mesh receiver is shown at 14. A central receive point is shown at 16.

The following value propositions inure to the benefit of users of such a three-transceiver mesh network system:
Optimal bandwidth to enable the scale required for wide area and high-density, single area surveillance systems;
The inherent redundancy advantages associated with mesh networks, which enable effective transmission when any one channel suffers from service interruption; and
Inherently greater security associated with multiple and random changes in channels.

This version will enable:
Encrypted 128-bit wireless technology for secure communications;
Built-in image stabilization to provide more useful video;
Advanced video functionality like pan, tilt and zoom to enable better monitoring of target objects;
Infrared illuminators to provide night viewing of objects;
Pressurized camera housing and MILSPEC connectors to assure reliability of the system even in extreme environments;
Portability, when appropriate, enabled by folding of the unit and transport in an over-the-shoulder backpack;
Tripod deployment, when appropriate, enabling a mast that can house the lightweight camera to a height of up to 22′ to enable a wide coverage area;
Integrated Bi-Directional Communication to enable audio communications when appropriate;
User Interfaces that enable simplicity of use; and
Low Power Consumption and, when appropriate, solar power.

This preferred embodiment is useful for both perimeter security and wide area surveillance system. The system provides both soldiers and first responders the ability to rapidly deploy a wireless video surveillance system which enables remote monitoring of critical areas without putting individuals in harms way. The infrastructure which is formed by the system will allow other sensors to utilize the newly formed wireless network. Sensors other than cameras can be fitted with this wireless technology, which will not only create a stronger network, but will provide a secure means of transmitting the data back to a central command and control interface. The present invention is useful for providing surveillance at military bases and the system can be rapidly set up in battlefield situations. Advancing enemy positions can be precisely located and destroyed even from the central station using GPS guided weapons.

### Variations

Persons skilled in this art will recognize that many variations to the above embodiments are possible and may be desirable. For example, sound detection equipment can be added to the surveillance units and microphones could also be added so that security personnel could communicate from the central station to people in the location of the surveillance unit. Other sensors that could be added include smoke detectors, radiation detectors, motion detectors, speed (Doppler) detectors.

While preferred embodiments of the present invention are described in detail, the reader should understand that the scope of the invention is not limited to those embodiments but should be determined by the claims and their legal equivalents.

We claim:

1. A surveillance system utilizing a mesh network having a large number of surveillance cameras, said surveillance system comprising:
A) at least one control station,
B) a plurality of surveillance units, each unit comprising:
1) a surveillance camera,
2) a plurality of limited range transceivers in direct or indirect communication with one or more of transceivers in other surveillance units or at the at least one control station,
wherein each of said at least one control station and each of said plurality of surveillance units defines a node and
wherein at least a portion of said plurality of surveillance units are equipped with at least three transceivers to provide simultaneous communication with one or more camera and at the same time receive and transmit information from other nodes.

2. The surveillance system as in claim 1 wherein said at least one control station comprises a control unit equipped transceiver chips to provide communications over multiple frequencies and communications protocols.

3. The surveillance system as in claim 2 wherein said control unit is adapted to convert signals from multiple frequencies into digital format for routing to other locations.

4. The surveillance system as in claim 2 wherein said control unit is adapted to provide redundancy to allow reliable communications to provide backup communication when one node or channel fails and to provide enhanced security due to random channel allocation.

5. The surveillance system as in claim 2 wherein at least some of said surveillance units are pole mounted.

6. The surveillance system as in claim 2 wherein at least some of said surveillance units are mounted on a tripod

7. The surveillance system as in claim 5 wherein at least some of said surveillance units are located on outdoor light poles.

8. The surveillance system as in claim 7 wherein said at least some of said surveillance units are part of light fixtures on said outdoor light poles.

9. The surveillance system as in claim 8 wherein said outdoor light poles are street light poles.
